(19) United States
(12) Patent Application Publication
(10) Pub. No.: US 2004/0007113 A1
(43) Pub. Date: Jan. 15, 2004

(54) Wipe dispenser and method for dispensing wipes

(76) Inventor: Priscilla Morrisey-Hawkins, Silver Spring, MD (US)

Correspondence Address: JOHN DODDS, 1707 N ST NW, WASHINGTON, DC, 20036, US

(21) Appl. No.: 10/195,587

(22) Filed: Jul. 15, 2002

(51) Int. Cl. B26D 7/00

(52) U.S. Cl. 83/649

(57) ABSTRACT

The present invention is a wipe dispenser device and method for dispensing wipes. The wipe-dispensing device comprises a dispenser or container that keeps wipes isolated from the exterior of the device. The wipes are kept in the inner compartment of the dispenser or container. The top or lid of the device isolates the wipes in the inner compartment from the exterior. This top or lid also secures the container from air, and seals the interior and exterior compartments of the device. Wipes are exposed when user manually press a button on the lid or activate a sliding door which in turn shall expose the wiping surface of the wipe inside of the container. Therefore, the rest of the wipes are not exposed to the exterior, only the wipe that is in use. User may manually handle the device, expose the wipe for cleaning the desired surface, and thereafter user may pull the wipe and detach it from the device by tearing off with a cutter slot on a side of the device.

### BACKGROUND & CROSS REFERENCES TO RELATED APPLICATIONS

Not applicable to this application.

### BACKGROUND: FEDERALLY SPONSORED RESEARCH

The invention subject matter of the present application was not a recipient of any federal support for its research and development.

### REFERENCE TO MICROFICHE APPENDIX

Not applicable to this application.

### BACKGROUND

1. Field of Invention

This invention relates to the field of wipe dispensers, most particularly to a wipe dispensing device that isolates the wipes from the exterior of the dispenser until user exposes the wipe to said exterior for cleaning a particular surface. In addition, this application describes a novel method for dispensing wipes, for user may hold the device by hand and clean the desired surface with the device without having to manually manipulate or enter into contact with the wipe itself until its disposal. Therefore, by means of this novel method, a wipe is kept inside the device without having contact neither with the exterior nor with a human hand. When the device's sliding door is opened, the wipe is exposed for cleaning the chosen surface. User may clean the desired surface, pull the wipe and tear it off from the cutter slot placed at a side of the device. Therefore, the remaining wipes inside the dispenser have not been in contact with the exterior, and therefore their disinfecting properties remain intact. Furthermore, the invention may be used for hygienic and disinfecting purposes.

Most wipe dispensing devices present in the prior art are containers that have an opening, enabling the consumer to manually remove the wipe from said device and subsequently disinfect and/or clean the desired surface. Therefore, user must place the wipe into contact with his or her hand and with the surroundings before the cleaning process. Due to this manual contact, the disinfecting properties of a wipe may be altered, and the disinfecting and cleaning may not be effective as intended. In addition, no device in the prior art discloses the Morrisey-Hawkins invention. There is no other wipe dispensing device and method for dispensing wipes in the prior art, particularly in the field of disinfecting wipes, that comprises a wipe dispensing device and method for dispensing wipes with the characteristics described herein under. Moreover, the Morrisey-Hawkins invention is a novel and useful device that comprises a wipe dispenser that isolates the wipes from the exterior of the device, therefore maintaining their disinfecting properties intact until user has finalized cleaning and disposes of the wipe.

The Morrisey-Hawkins invention has been designed primarily to be used as: (i) wipe dispenser that seals the wipe inside the container, and enables user to clean surfaces without getting the wipe into contact with his or her hands prior to the cleaning process; and (ii) a method for dispensing wipes that maintains the wipes inside the container and prevents their contact with the exterior prior to user opening the sliding door and exposing the wipe for the cleaning process.

2. Discussion of Prior Art

There are several wipe dispensers and systems for dispensing wipes in the prior art. Nevertheless, none of the inventions in the prior art disclose the device and method subject matter of the present application. For example, U.S. Pat. No. 3,967,756 (Barish, 1976) describes a Wet Wipe Dispenser in which user removes the tissue from the upper section of the dispenser. In addition, U.S. Pat. No. 5,560,514 (Frazier, 1996) describes a Wet Wipe Dispensing Nozzle With Rotatable Port. This patent refers to a center flow dispenser for dispensing saturated wipers including a dispensing nozzle affixed to the container of wet wipes. Furthermore, U.S. Pat. No. 5,785,179 (Buczwinski, 1998) discloses a Container for Wet Wipes Having an Improved Closure Mechanism; U.S. Pat. No. 6,056,235 (Brozinsky, 2000) pertains to a Refillable Dispenser For Replacing Standard Roll of Toilet Tissue with Roll of Pre-Moist Wipes; U.S. Pat. No. 6,092,690 (Bitowft et al, 2000) illustrates a Wet Wipe Container Having a Hinged Cover used for a stack of moist wipes; U.S. Pat. No. 6,158,614 (Haines et al, 2000) refer to a Wet Wipe Dispenser With Refill Cartridge; U.S. Pat. No. 6,189,730 B1 (McClymonds, 2001) refers to a Wet Towelette and Dry Towel Dispenser Apparatus which may be wall or door mounted and which may hold dry and wet towels; U.S. Pat. No. 6,269,969 B1 (Huang et al, 2001) disclose a Wet Wipes Container with Improved Closure; U.S. Pat. No. 6,269,970 B1 (Huang et al, 2001) describes a Wet Wipes Container Having a Tear Resistant Lid; and U.S. Pat. No. 6,346,153 (Lake et al, 2002) discloses a Wet or Dry Web Dispenser. This dispenser provides a dry web in which a liquid can be introduced when desired, thus being able to deliver a dry or a wet wipe to user at his or her preference. This patent does not disclose the Morrisey-Hawkins invention.

With respect to the method described hereinunder, it is a new and useful method for dispensing wipes not previously disclosed in the prior art. U.S. patent application Ser. No. US2002/0005452 A1 describes a System and Method for Refilling a Dispenser (Romme et al); U.S. patent application Ser. No. US 2002/0023932 A1 disclose a System for Dispensing Plurality of Wet Wipes (Faulks et al); U.S. patent application Ser. No. US2002/0036208 A1 (Faulks et al) refers to a Wipes Dispensing System; U.S. patent application Ser. No. US 2001/0039786 describe a Method for Providing Wet Wipes (Romme et al); however, none of the referred applications disclose the Morrisey-Hawkins method.

In addition, most of the aforementioned devices, methods or systems are intended for user to have immediate contact with the wipe or towelette prior to performing the cleaning or disinfecting process, unlike the invention subject of this application. Moreover, the abovementioned methods disclosed in the prior art do not require user to open a section of the dispenser in order to have the wipe available and to manually hold the device to clean the desired surface. None of the referred methods prevent the wipe to have contact with the exterior surrounding the dispenser, including air, and therefore do not effectively protect the disinfecting properties of the wipes from external materials and surroundings. Therefore, by means of this method, user will be able to clean or disinfect a surface without touching the wipe, and may dispose of the same after cleaning has concluded. Once the dispenser's sliding door is closed, the wipes will once again be isolated and protected from exterior air, substances and materials, preserving its disinfecting properties. In conclusion, related devices and methods in the prior art do not disclose the claimed Morrisey-Hawkins device and method.

### SUMMARY

The present invention is a wipe dispenser device and method for dispensing wipes. The wipe-dispensing device comprises a dispenser or container that keeps wipes isolated from the exterior of the device. The wipes are kept in the inner compartment of the dispenser or container. The top or lid of the device isolates the wipes in the inner compartment from the exterior. This top or lid also secures the container from air, and seals the interior and exterior compartments of the device. Wipes are exposed when user manually press a button on the lid or activate a sliding door which in turn shall expose the wiping surface of the wipe inside of the container. Therefore, the rest of the wipes are not exposed to the exterior, only the wipe that is in use. User may manually handle the device, expose the wipe for cleaning the desired surface, and thereafter user may pull the wipe and detach it from the device by tearing off with a cutter slot on a side of the device. The remaining wipes are still isolated from the exterior of the container or dispenser for an air closure snugly snaps onto the top or lid, and over to the top of the cutter slot sealing off the air and exterior and keeping the wipes isolated.

### OBJECTS & ADVANTAGES

Several advantages of the Morrisey-Hawkins invention are disclosed in the present application. The objects and advantages of this wipe dispenser and method for dispensing wipes disclosed herein include but are not limited to providing the wipe dispensing field and field of methods for dispensing wipes. A novel device that will enable user to clean a desired surface with an intact wipe (without prior exposure to the exterior of the device). Furthermore, this invention has the advantage of being a novel and useful method for dispensing device providing user with intact wipes with no prior contact with the exterior of the container or dispenser.

Other objects, features and advantages will become apparent from a consideration of the following detailed description and from the accompanying drawings and the claims of the invention.

In view of the foregoing, various objects and advantages of the present invention include the following:

1. One object of the present invention is to provide a device that isolate wipes from the exterior of the device. This will allow user to manually handle the device and clean a desired surface with a completely clean wipe. Therefore, this invention provides increased hygiene for its user.

2. In addition, another object is to provide a wipe container or dispenser for wipes in general, such as but not limited to wet, moist, dry wipes, scented, unscented, and of various cleaning properties.

3. Another object of the present invention is to provide a novel method for dispensing wipes in which the wipe is isolated from the dispensing device to cleaning the surface. This provides increased hygiene for user.

4. This invention has further advantages such as being a hygienic cleansing device that may be used in distinct surfaces. It may be used for cleaning items at user's home or office environments, such as but not limited to telephones, cellular or mobile phones, telephone receivers, phone ear piece, phone base, desk top, speakers, computer or typewriter keyboards, computer mouse, door knobs, desk accessories (such as scissors, staples, tape dispenser), refrigerators, refrigerator handles, counter tops, sinks, cabinet handles or knobs, remote controls for electronic appliances. I addition, this device may also be used for user to cleanse his or her hands.

### DESCRIPTION OF THE INVENTION

The invention subject of this application comprises a wipe dispenser device and method for dispensing wipes. The structural features of the invention comprise:

(a) A dispenser or container that includes a top section consisting of a top or lid, and a bottom section. The latter may have two-inner compartments, one for housing tissues, and one where the tissue passes through a thread mound and finally to a cutter slot for user to tear off the wipes.

(b) A button located at the exterior of the bottom part of the dispenser or container. This button shall activate a sliding door if pressed by user.

(c) An opening that may include but is not limited to a sliding door or window. When opened, the wipe is exposed to the exterior for cleaning a desired surface.

(d) A cutter slot.

(e) Wipes.

(f) A thread slot.

(g) A mound or raised plastic that shall help push the wipe to opening.

(h) An air closure to seal the cutter slot.

### DESCRIPTION OF DRAWINGS

Drawings of the Morrisey-Hawkins invention are enclosed to this application.

FIG. 1—This is a drawing of the exterior of the wipe dispenser when closed.

FIG. 2—This is a drawing of the wipe dispenser showing the roll of wipes inside the sealed container, and the special mechanism for their dispensing.

FIG. 3—This is a drawing of a detachable lid from the dispenser.

FIG. 4—This is a drawing of the base showing the cutting slot and the mound.

FIG. 5—This is a drawing of the sliding door.

FIG. 6—This is a drawing of the exterior window that exposes the wipe.

FIG. 7—This is a drawing of the bottom view of the dispenser.

FIGS. 8-11—This shows drawings showing various methods to attach the base of the device, such as screws, adhesive, Velcro.

FIG. 12—This is a drawing of a side view showing the cutter slit.

FIGS. 13-22—This shows various shapes of air closures and different cutter shapes.

FIG. 23—This is a drawing of detachable lid.

FIG. 24—This is a drawing of a removable window section.

FIG. 25—This is a drawing of the detached window section.

FIGS. 26 and 28—This is a drawing a dispenser with ribbing for grip, but with exposed window.

FIGS. 27 and 29—This is a drawing of a dispenser with ribbing for grop, but without the window being exposed.

FIGS. 30 and 32—This is drawing of a dispenser with a flap opening for dispensing wipes.

FIGS. 31 and 33—This is a drawing of a dispenser with an top flap opening for dispensing wipes.

FIG. 34—This is a drawing of a sealed unit with no sliding door, no air closure.

FIG. 35—This is a drawing of a refillable unit

FIG. 36—This is a drawing of a non refillable unit, but with a door.

FIG. 37—This is a drawing of a non refillable unit with a door.

FIGS. 38 and 40—This is a drawing of a unit with a ribbed window for grip.

FIGS. 39 and 41—This is a drawing of unit with a flap window.

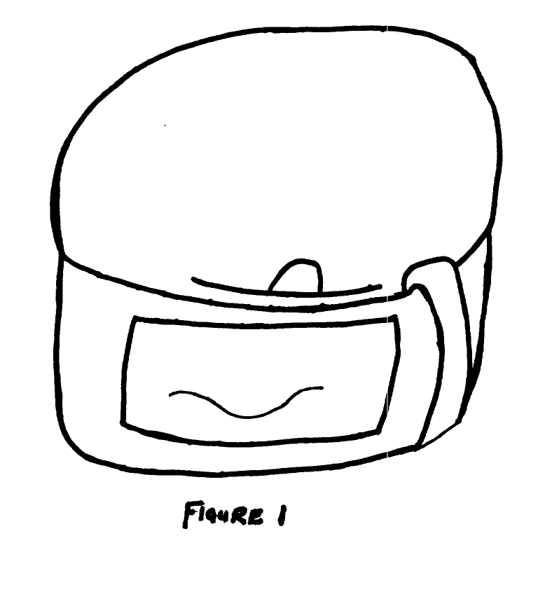

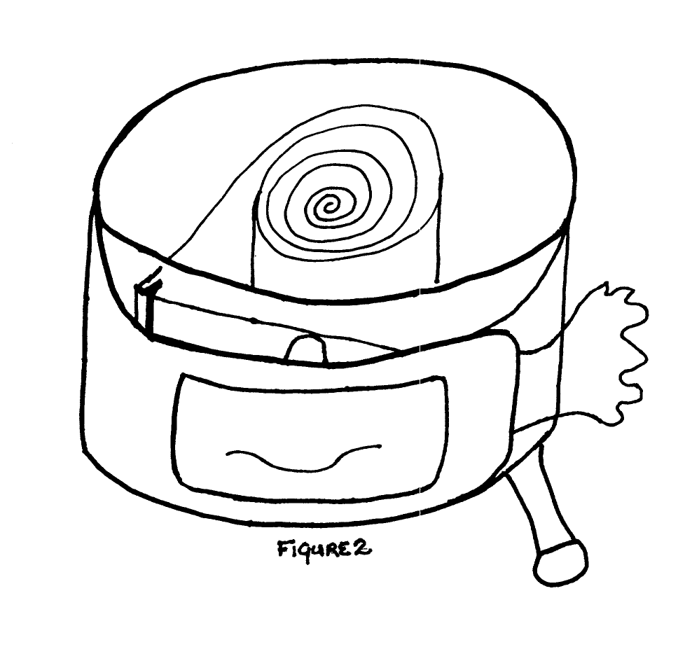

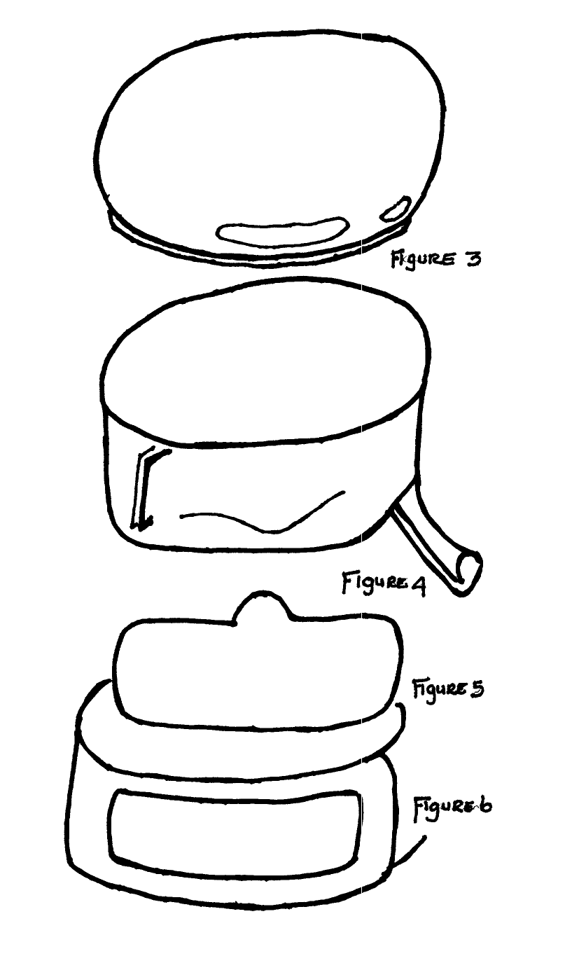

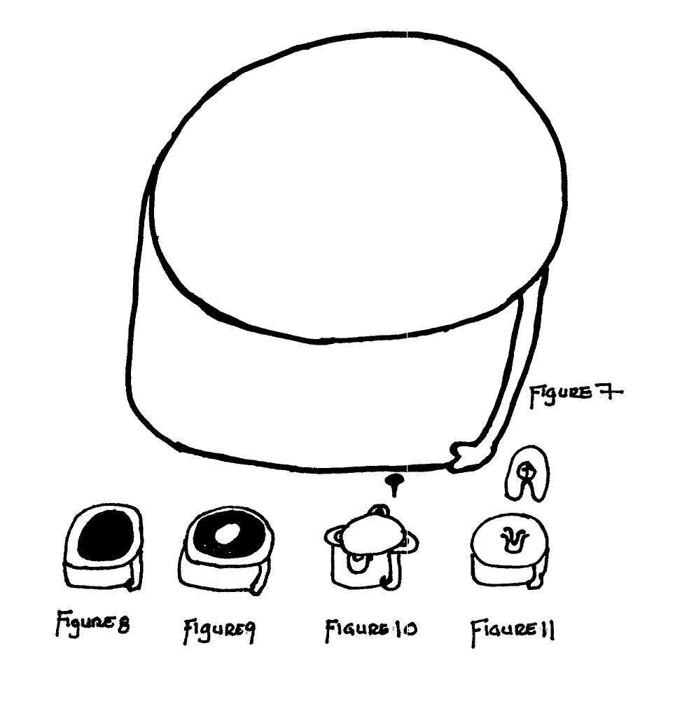

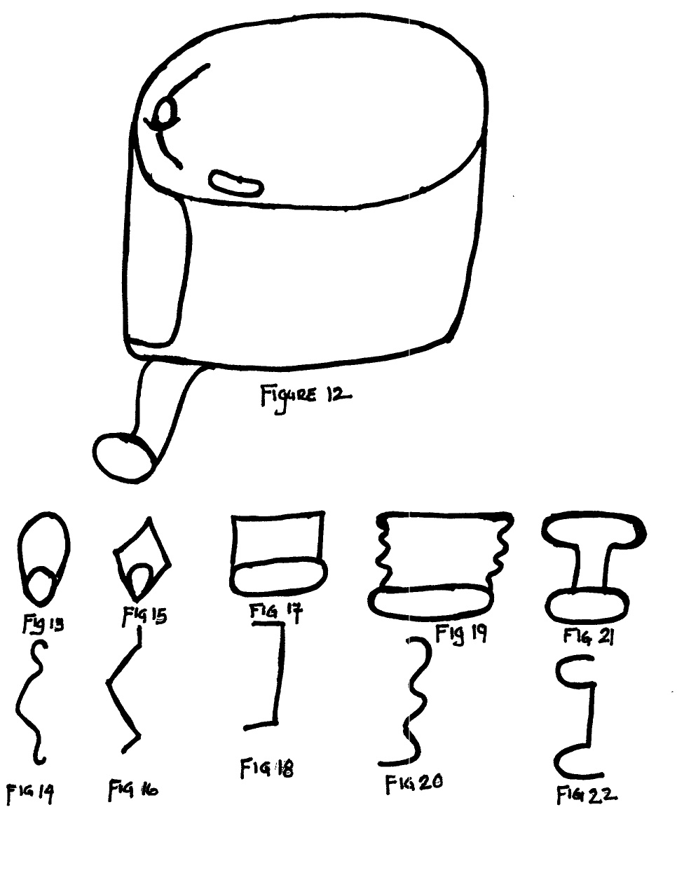

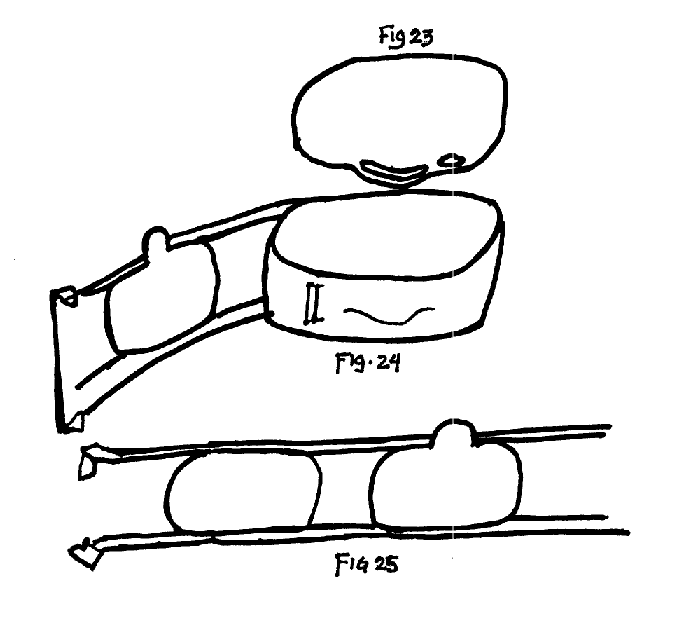

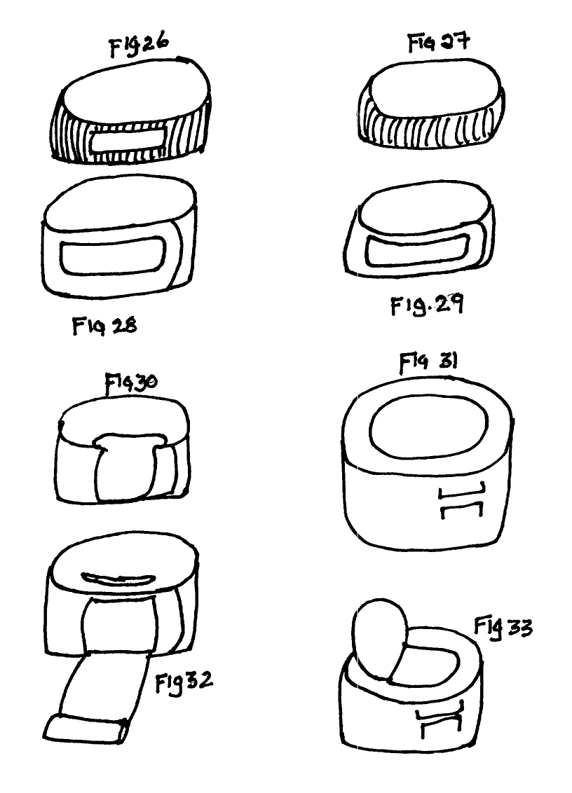

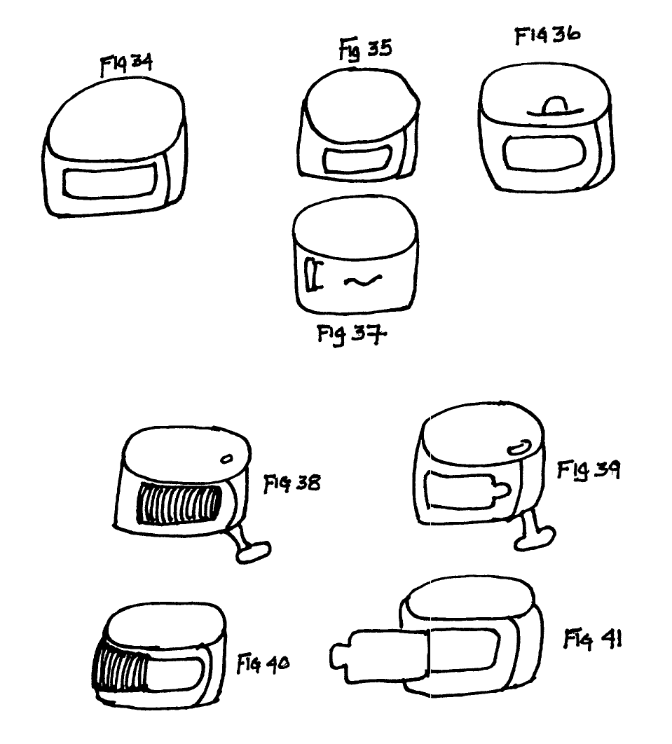

### OPERATION OF INVENTION

The invention is operated by holding the container that contains the sealed wipes, and then individual wipes are then used from the container and passed across the surface of the item to be disinfected. This can be done in a way that does not require the wipe to come into contact with the human hand. The sealed wipes are also kept disinfected because there is no need to open the container.

The invention can be used as a mechanism to disinfect wipe a wide range of items, including, but not limited to, telephone receiver, telephone earpiece, telephone base, cellular phone, hands, desk top, desk accessories, door handles, speakers, keyboards, door knobs, refrigerator, refrigerator handle, countertop, sinks, cabinets, remote controls etc.

### Description and Operation of Alternative Embodiments

The invention subject of this application may be used in a variety of embodiments. The holder package may be of various materials, may be ornamented in various ways. The wipes may be scented or plain. The wipes may be of various materials, of given strength. Different types of disinfecting material may also be used.

The scope of the subject invention shall be judged by the claims and not limited to the embodiment described herein.

### Conclusion, Ramification & Scope of Invention

The scope of the invention described herein is only provided as an example of the same. The above specifications shall not limit the scope of the invention for its scope shall be determined as described within the claims of the invention in this application.

### List of Reference Numerals

This is not applicable to this application

I claim:

1. A method and a device for dispensing wipes comprising:
a moisture impermeable dispensing container to hold the supply of sterilizing wipes,
a double compartment, the first for housing said sterilizing wipes, the second where the wipe passes through a thread slot and over a mound to a cutter slot,
an opening which may include, but is not limited to a sliding window or door, so as to expose said wipe
a cutter slot,
disposable, sterilizing wipes,
a thread slot,
a mound or raised plastic that assists in pushing the wipe through the opening,
a button that can also be pressed and that forces the wipe through the device with a cutter slot at the end, so the wipe can be pushed through and cut off,
an air closure to seal the cutter slot.

2. The device described in claim 1 wherein the referred supply of wipes may be moistened with a sterilizing material.

3. The device described in claim 1 wherein the wipes are exposed while still attached to said container.

4. The device described in claim 1 wherein the button located on the dispenser may be used to open a door or window to expose said wipe.

5. The device described in claim 1 wherein the dispensing structure has a cutter slot to allow a cutter bar to cut said wipe.

6. The device described in claim 1 wherein the cutter slot contains a razor edge to allow for cutting of wipe.

7. The device described in claim 1 wherein the dispensing structure has a thread slot that allows for passage of wipe as a flat sheet.

8. The device described in claim 1 wherein the dispensing container has a raised lip that helps to push the wipe to the opening.

9. The device described in claim 1 wherein the cutter slot of claim 5 is air tight sealed.

10. The device described in claim 1 wherein the button may push said wipe all the way through the cutter slot and cut, thus releasing a wipe.
